(19) United States
(12) Patent Application Publication
(10) Pub. No.: US 2025/0385309 A1
(43) Pub. Date: Dec. 18, 2025

(54) Electrolyte for Lithium Secondary Battery and Lithium Secondary Battery Including the Same

(71) Applicants: SK On Co., Ltd., Seoul (KR); SK Innovation Co., Ltd., Seoul (KR)

(72) Inventors: Min Hee LEE, Daejeon (KR); Myoung Lae KIM, Daejeon (KR); Ki Sung PARK, Daejeon (KR); In Haeng CHO, Daejeon (KR)

(21) Appl. No.: 19/235,816

(22) Filed: Jun. 12, 2025

(30) Foreign Application Priority Data
Jun. 17, 2024 (KR) 10-2024-0078334

(51) Int. Cl. H01M 10/0567; H01M 10/052; H01M 10/0568; H01M 10/0569

(52) U.S. Cl. CPC H01M 10/0567; H01M 10/052; H01M 10/0568; H01M 10/0569; H01M 2300/004

(57) ABSTRACT

An electrolyte for a lithium secondary battery according to the present disclosure includes: a lithium salt; an organic solvent; an additive comprising a compound including a carbon-carbon triple bond, a linear ether group, and a 4- or 5-membered cyclic ether group; and a sulfur compound including a sulfur-containing heterocyclic structure.

### CROSS-REFERENCE TO RELATED APPLICATION AND CLAIM OF PRIORITY

This application claims priority to Korean Patent Application No. 10-2024-0078334 filed on Jun. 17, 2024 in the Korean Intellectual Property Office (KIPO), the entire disclosure of which is incorporated by reference herein.

### BACKGROUND OF THE INVENTION

### 1. Field of the Invention

This invention relates to an electrolyte for a lithium secondary battery and a lithium secondary battery including the electrolyte.

### 2. Description of the Related Art

A secondary battery is a battery that can be repeatedly charged and discharged. With the rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as a hybrid vehicle as a power source thereof.

Examples of the secondary batteries may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design, such that development thereof is progressing in this regard.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

For example, the cathode may include a lithium metal oxide capable of reversibly intercalating and deintercalating lithium as a cathode active material.

Meanwhile, in the lithium secondary battery, structural deformation of the lithium metal oxide, side reactions of the electrolyte, and the like may occur during repeated charging and discharging and under a high-temperature environment. Accordingly, it is necessary to develop a lithium secondary battery that provides excellent cycle life characteristics and thermal stability even under repeated charging and discharging and high-temperature conditions.

### SUMMARY OF THE INVENTION

An object of the present disclosure is to provide an electrolyte for a lithium secondary battery with improved high-temperature cycle life characteristics.

Another object of the present disclosure is to provide a lithium secondary battery with improved high-temperature cycle life characteristics.

An electrolyte for a lithium secondary battery according to exemplary embodiments of the present disclosure includes: a lithium salt; an organic solvent; an additive comprising a compound including a carbon-carbon triple bond, a linear ether group, and a 4- or 5-membered cyclic ether group; and a sulfur compound including a sulfur-containing heterocyclic structure.

According to an embodiment, the compound may be represented by Formula 1 below.

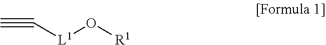

In Formula 1, L¹ may be an alkylene group having 1 to 5 carbon atoms, and R¹ may be a hydrocarbon group having 3 to 30 carbon atoms and including a 4- or 5-membered cyclic ether group.

According to an embodiment, L¹ in Formula 1 above may be a methylene group.

According to an embodiment, R¹ in Formula 1 above may be a hydrocarbon group having 3 to 6 carbon atoms and including a 4- or 5-membered cyclic ether group.

According to an embodiment, the content of the additive may be 0.1% by weight to 10% by weight based on the total weight of the electrolyte.

According to an embodiment, the content of the additive may be 0.2% by weight to 0.5% by weight based on the total weight of the electrolyte.

According to an embodiment, the sulfur compound may include at least one oxygen-sulfur double bond.

According to an embodiment, the sulfur compound may include a sultone compound or a cyclic sulfate compound.

According to an embodiment, the sulfur compound may include at least one selected from the group consisting of 1,3-propane sultone, 1,3-propene sultone, 1,4-butane sultone, 1,2-ethylene sulfate, 1,2-propylene sulfate, trimethylene sulfate, and methyltrimethylene sulfate.

According to an embodiment, the content of the sulfur compound may be 0.01% by weight to 10% by weight based on the total weight of the electrolyte.

According to an embodiment, a ratio of the content of the sulfur compound to the content of the additive in the total weight of the electrolyte may be 0.1 to 10.

According to an embodiment, the electrolyte for a lithium secondary battery may further include an auxiliary additive including at least one selected from the group consisting of an unsaturated cyclic carbonate compound, a halogen-substituted cyclic carbonate compound, a fluorine-substituted phosphate compound, and an oxalato phosphate compound.

According to an embodiment, the content of the auxiliary additive may be 0.1% by weight to 10% by weight based on the total weight of the electrolyte.

A lithium secondary battery according to exemplary embodiments of the present disclosure includes: a cathode; an anode disposed opposite to the cathode; and the electrolyte for a lithium secondary battery.

According to an embodiment of the present disclosure, the electrolyte for a lithium secondary battery may include an additive comprising a compound including a carbon-carbon triple bond, a linear ether group, and a 4- or 5-membered cyclic ether group, and a sulfur compound including a sulfur-containing heterocyclic structure, thereby forming a uniform and stable solid electrolyte interphase (SEI) on the electrode surface

Accordingly, side reactions of the electrolyte under a high-temperature environment may be reduced, thereby suppressing gas generation and thickness expansion of the battery. As a result, it is possible to implement a lithium secondary battery with improved high-temperature storage characteristics by maintaining the capacity and resistance of the battery under a high-temperature environment. In addition, the lithium secondary battery may maintain the capacity even during repeated charging and discharging at high temperatures, thereby improving the high-temperature cycle life characteristics.

The electrolyte of the present disclosure may be widely applied in green technology fields, such as electric vehicles, battery charging stations, as well as solar power generation, wind power generation, and the like, which use the batteries. In addition, the electrolyte of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a plan view schematically illustrating a lithium secondary battery according to exemplary embodiments; and

FIG. 2 is a cross-sectional view schematically illustrating the lithium secondary battery according to exemplary embodiments.

### DETAILED DESCRIPTION OF THE INVENTION

According to exemplary embodiments of the present disclosure, there is provided an electrolyte for a lithium secondary battery which includes an additive comprising a compound including a carbon-carbon triple bond, a linear ether group, and a 4- or 5-membered cyclic ether group, and a sulfur compound including a sulfur-containing heterocyclic structure. In addition, there is provided a lithium secondary battery with improved high-temperature storage characteristics and high-temperature cycle life by including the electrolyte.

As used herein, the term “alkyl” is an organic radical derived from an aliphatic hydrocarbon by removing one hydrogen, and may include a straight or branched chain, or both forms thereof. The alkyl may have 1 to 10 carbon atoms, specifically 1 to 7 carbon atoms, or 1 to 5 carbon atoms, and more specifically 1 to 3 carbon atoms. An example of the alkyl includes methyl, ethyl, propyl, isopropyl, butyl, isobutyl, t-butyl, pentyl, hexyl, ethylhexyl, or the like, but it is not limited thereto.

As used herein, the “X compound” may refer to a compound including an X unit attached to a matrix, or a derivative of the X compound.

Hereinafter, the embodiments of the present disclosure will be described in detail. However, these embodiments are merely examples, and the present disclosure is not limited to the specific embodiments described as example.

According to exemplary embodiments of the present disclosure, an electrolyte for a lithium secondary battery (hereinafter, also abbreviated as “the electrolyte”) includes: a lithium salt; an organic solvent; an additive comprising a compound including a carbon-carbon triple bond, a linear ether group, and a 4- or 5-membered cyclic ether group; and a sulfur compound including a sulfur-containing heterocyclic structure.

In exemplary embodiments, the electrolyte includes an additive. The additive includes a compound including a carbon-carbon triple bond, a linear ether group, and a 4- or 5-membered cyclic ether group.

When the electrolyte includes the additive, a thermally stable solid electrolyte interphase (SEI) may be formed, thereby suppressing gas generation and an increase in battery thickness even during repeated charging and discharging under high-temperature conditions. Accordingly, the additive may improve the stability of the electrolyte and enhance the safety of the lithium secondary battery at high temperatures, thereby improving the high-temperature cycle life characteristics and high-temperature storage characteristics thereof.

When the compound includes a carbon-carbon triple bond at its terminal, the reactivity toward electrons may be improved compared to the organic solvent. Accordingly, it may be reduced at a lower voltage than that of polar solvents, thereby suppressing side reactions of the solvents. In addition, it may form a uniform and stable SEI film even after long-term charge and discharge. Therefore, it may reduce gas generated in a high-temperature environment, and may improve the high-temperature cycle life characteristics and high-temperature storage characteristics.

As used herein, the term “linear ether group” may refer to a structure in which two groups bonded to an ether group are not connected to each other. As used herein, the term “cyclic ether group” may refer to a structure in which two groups bonded to an ether group are connected to each other to form a ring.

When the compound includes a linear ether group, the mobility of ions and electrons may be improved, thereby enhancing the charging and discharging speeds. In addition, it may form an SEI film with improved safety at high temperatures, thereby suppressing the side reactions of the electrolyte in a high-temperature environment. Accordingly, electrical stability under a high-temperature environment may be improved, and the gas generated through side reactions of the electrolyte may be suppressed. As a result, high-temperature cycle life characteristics and high-temperature storage characteristics may be improved.

When the compound includes a 4- or 5-membered cyclic ether group, its electrical activity at high temperatures may be increased. Accordingly, the deterioration in capacity of the secondary battery may be suppressed, and the stability of the electrolyte may be improved. In addition, the electrochemical performance and reactivity in a high-temperature environment may be improved, thereby enabling the implementation of a high-voltage and high-capacity lithium secondary battery.

In one embodiment, the additive may include a compound represented by Formula 1 below.

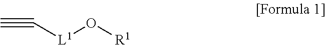

In Formula 1 above, L¹ may be an alkylene group having 1 to 5 carbon atoms.

In one embodiment, in Formula 1 above, L¹ may be a substituted or unsubstituted alkylene group having 1 to 5 carbon atoms. For example, in L¹, at least one of the hydrogens bonded to each carbon atom may be replaced with a substituent. Non-limiting examples of the substituent may include functional groups such as a halogen, a hydroxyl group, a carboxyl group, an amine group, an amide group, a cyano group, a thiol group, a sulfonic acid group and the like.

In one embodiment, in Formula 1 above, L¹ may be a methylene group, an ethylene group, or a propylene group.

In Formula 1 above, R¹ may be a hydrocarbon group having 3 to 30 carbon atoms and including a 4- or 5-membered cyclic ether group.

As used herein, the term “hydrocarbon group” may collectively refer to an organic group including a straight-chain, branched-chain, or cyclic structure of a carbon skeleton, and having a structure in which hydrogen is bonded to the carbon atom. For example, the hydrocarbon group may include a straight-chain or branched-chain aliphatic hydrocarbon group, a cyclic aliphatic hydrocarbon group, or an aromatic hydrocarbon group, but it is not limited thereto.

The straight-chain or branched-chain aliphatic hydrocarbon group may include straight-chain or branched-chain aliphatic hydrocarbon groups such as a methyl group, an ethyl group, a propyl group, an isopropyl group, a butyl group, a sec-butyl group, an isobutyl group, a tert-butyl group, a pentyl group, a sec-pentyl group, a 1-ethylpropyl group, an isopentyl group, a 2,2-dimethylpropyl group, a hexyl group, a 2-methyl pentyl group, a 3-methyl pentyl group, a 4-methyl pentyl group, a 2,2-dimethylbutyl group, a 2,3-dimethylbutyl group and the like.

The cyclic aliphatic hydrocarbon group may be monocyclic or polycyclic. The cyclic aliphatic hydrocarbon group may include a cyclopropyl group, a cyclobutyl group, a cyclopentyl group, a cyclohexyl group, a cyclopropenyl group, a cyclopentenyl group, a cyclohexenyl group and the like.

The aromatic hydrocarbon group may be monocyclic or polycyclic. The aromatic hydrocarbon group may include a phenyl group, a naphthalene group, an anthracene group, a phenanthracene group, a fluorene group, a pyrene group, a phenalene group, an indene group, a biphenylene group, a diphenylmethylene group, a tetrahydronaphthalene group, a dihydroanthracene group, a tetraphenylmethylene group, a triphenylmethylene group, a pyrrole group, a pyridine group and the like.

In exemplary embodiments, any hydrogen included in the hydrocarbon group may be replaced with a substituent. The substituents may be the same as those described above for L¹.

In exemplary embodiments, the hydrocarbon group may have a structure in which a 4- or 5-membered cyclic ether group is bonded to the terminal of an aliphatic hydrocarbon group. Alternatively, the hydrocarbon group may be a structure in which a 4- or 5-membered cyclic ether group shares a carbon with any of the methylene groups of the aliphatic hydrocarbon group. In this case, the carbon atom bonded to another group in the 4- or 5-membered cyclic ether group may not be bonded to hydrogen.

In exemplary embodiments, R¹ in Formula 1 above may be a hydrocarbon group having 3 to 20 carbon atoms and including a 4- or 5-membered cyclic ether group, a hydrocarbon group having 3 to 10 carbon atoms, or a hydrocarbon group having 3 to 6 carbon atoms.

In exemplary embodiments, the additive may include at least one of the compounds represented by Formulas 2 and 3 below.

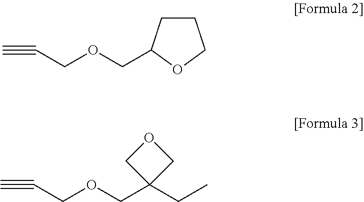

According to exemplary embodiments, the content of the additive may be 0.1% by weight (“wt %”) to 10 wt % based on the total weight of the electrolyte. According to some embodiments, the content of the additive may be 0.1 wt % to 5 wt %, 0.1 wt % to 1 wt %, or 0.2 wt % to 0.5 wt % based on the total weight of the electrolyte.

When the additive is included within the above content range, decomposition of the electrolyte may be prevented, and gas generation and an increase in battery thickness may be suppressed. Accordingly, the high-temperature stability of the electrolyte may be achieved, and a lithium secondary battery with improved high-temperature storage properties and high-temperature cycle life characteristics may be implemented.

In exemplary embodiments, the sulfur compound may include a sulfur-containing heterocyclic structure. By including the sulfur-containing heterocyclic structure, it may contribute to the formation of a stable SEI film, and thus, side reactions of the electrode may be suppressed, thereby reducing gas generation in a high-temperature environment.

In exemplary embodiments, the electrolyte may include a sulfur compound including at least one oxygen-sulfur double bond. Accordingly, the sulfur compound may be decomposed at high temperatures, and sulfur atoms may form bonds with the electrode surface to create a stable SEI film, thereby improving the stability of the electrode surface. In addition, side reactions between the electrode and the electrolyte may be suppressed, and gas generation that occurs when exposed to high temperatures may be reduced. Therefore, the thickness expansion of the battery may be suppressed, thereby improving high-temperature storage characteristics and high-temperature cycle life characteristics.

In an exemplary embodiment, the sulfur compound may include a sultone compound or a cyclic sulfate compound. For example, the sulfur compound may include at least one selected from the group consisting of 1,3-propane sultone, 1,3-propene sultone, 1,4-butane sultone, 1,2-ethylene sulfate, 1,2-propylene sulfate, trimethylene sulfate, and methyltrimethylene sulfate. By including the sultone compound or the cyclic sulfate compound, an SEI film with improved structural stability in a high temperature environment may be formed. Therefore, storage characteristics and cycle life characteristics under high-temperature environments may be improved.

In an exemplary embodiment, the content of the sulfur compound may be 0.01 wt % to 10 wt % based on the total weight of the electrolyte.

The content of the sulfur compound may be 0.05 wt % to 5 wt %, 0.1 wt % to 3 wt %, or 1 wt % to 2.5 wt % based on the total weight of the electrolyte. Within the above range, a uniform SEI film may be formed in a high temperature environment, thereby improving high temperature storage characteristics and high temperature cycle life characteristics.

In an exemplary embodiment, a ratio of the content of the sulfur compound to the content of the additive in the total weight of the electrolyte may be 0.1 to 10. In some embodiments, the ratio of the content of the sulfur compound to the content of the additive in the total weight of the electrolyte may be 0.1 to 5 or 0.5 to 2. Within the above range, the consumption of the electrolyte due to side reactions with the electrode surface in a high temperature environment may be suppressed. Accordingly, unnecessary gas generation and the volume expansion rate of the battery may be reduced.

In an exemplary embodiment, the electrolyte may further include an auxiliary additive. For example, the auxiliary additive may include at least one selected from the group consisting of an unsaturated cyclic carbonate compound, a halogen-substituted cyclic carbonate compound, a fluorine-substituted phosphate compound, and an oxalato phosphate compound.

The unsaturated cyclic carbonate compound may include vinyl ethylene carbonate (VEC), vinylene carbonate (VC), etc.

The halogen-substituted cyclic carbonate compound may include fluoroethylene carbonate (FEC), chloroethylene carbonate, etc.

The fluorine-substituted phosphate compound may include lithium difluorophosphate (LiPO₂F₂), etc.

The oxalato phosphate compound may include lithium difluoro bis(oxalato)phosphate, etc.

By adding the auxiliary additive, the stability of the electrode and the ionic conductivity of the electrolyte may be further improved. The auxiliary additive may be included in an appropriate amount within a range that does not inhibit the migration of lithium ions in the electrolyte.

According to exemplary embodiments, the content of the auxiliary additive may be 0.1 to 10 wt %, 0.5 to 5 wt %, or 1 to 3 wt % based on the total weight of the electrolyte.

In one embodiment, the weight ratio of the auxiliary additive to the weight of the additive in the electrolyte may be 0.1 to 10, greater than 1 and 10 or less, or 5 to 10 or less. Within the above range, a lithium secondary battery with improved cycle life characteristics along with high-temperature storage characteristics may be implemented.

According to exemplary embodiments, the lithium salt may include one or more lithium salt compounds. For example, the lithium salt may be represented as Li⁺X⁻, and non-limiting examples of an anion (X⁻) of the lithium salt may include PF₆⁻, F⁻, Cl⁻, Br⁻, I⁻, NO₃⁻, N(CN)₂⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, BF₄⁻, B(C₂O₄)₂; BF₂(C₂O₄)⁻, B(C₃H₂O₄)₂⁻, BF₂(C₃H₂O₄)⁻, B(C₃HO₄F)₂⁻, B(C₃F₂O₄)₂⁻, etc. The anions may be used alone or in combination of two or more thereof as lithium salts.

In some embodiments, the lithium salt may be included at a concentration of 0.01 M to 5 M, 0.01 M to 4 M, 0.5 M to 3 M, or 0.5 M to 2 M based on the organic solvent. Within the concentration range, the lithium ions and/or electrons may migrate smoothly during charging and discharging of the lithium secondary battery, thereby enhancing the capacity and improving the charge and discharge efficiency.

The lithium salt may be included in an amount of 0.01 wt % to 5 wt % or 0.1 wt % to 2 wt % based on the total weight of the electrolyte. Within the range, the transfer of lithium ions and/or electrons during charging and discharging of the lithium secondary battery may be promoted, thereby enhancing the capacity and improving the charge and discharge efficiency.

In an exemplary embodiment, the organic solvent may be used as a balance or a remaining amount excluding solid components such as a lithium salt, a carbon-carbon triple bond, a linear ether group, and a 4- or 5-membered cyclic ether group, and an auxiliary additive.

The organic solvent may provide sufficient solubility for the lithium salt and the auxiliary additive, etc., and may include an organic compound that is electrochemically stable without exhibiting reactivity in the lithium secondary battery.

In some embodiments, the organic solvent may include a carbonate solvent, an ester solvent, an ether solvent, a ketone solvent, an alcohol solvent, and an aprotic solvent. These may be used alone or in combination of two or more thereof.

Examples of the carbonate solvents may include dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), fluoroethylene carbonate (FEC), butylenes carbonate, etc.

Examples of the ester solvents may include methyl acetate (MA), ethyl acetate (EA), n-propyl acetate (n-PA), 1,1-dimethylethyl acetate (DMEA), methyl propionate (MP), ethyl propionate (EP), gamma-butyrolactone (GBL), decanolide, valerolactone, mevalonolactone, caprolactone, etc.

Examples of the ether organic solvents may include dibutyl ether, tetraethylene glycol dimethyl ether (TEGDME), diethylene glycol dimethyl ether (DEGDME), dimethoxy ethane, 2-methyltetrahydrofuran, tetrahydrofuran, etc.

An example of the ketone solvents may include cyclohexanone. Examples of the alcohol solvents may include ethyl alcohol, isopropyl alcohol, etc.

The aprotic solvent may include a nitrile solvent, an amide solvent such as dimethyl formamide (DMF), a dioxolane solvent such as 1,3-dioxolane, a sulfolane solvent, etc.

In one embodiment, at least two of ethylene carbonate (EC), ethyl methyl carbonate (EMC), dimethyl carbonate (DMC), and diethyl carbonate (DEC) may be used in combination as the organic solvent.

The content of the organic solvent may be 80 wt % to 96 wt %, or 90 wt % to 95 wt % based on the total weight of the electrolyte.

A lithium secondary battery according to exemplary embodiments may include a cathode, an anode, a separation membrane interposed between the cathode and the anode, and the above-described electrolyte for a lithium secondary battery.

Hereinafter, the lithium secondary battery according to exemplary embodiments will be described in more detail with reference to the drawings.

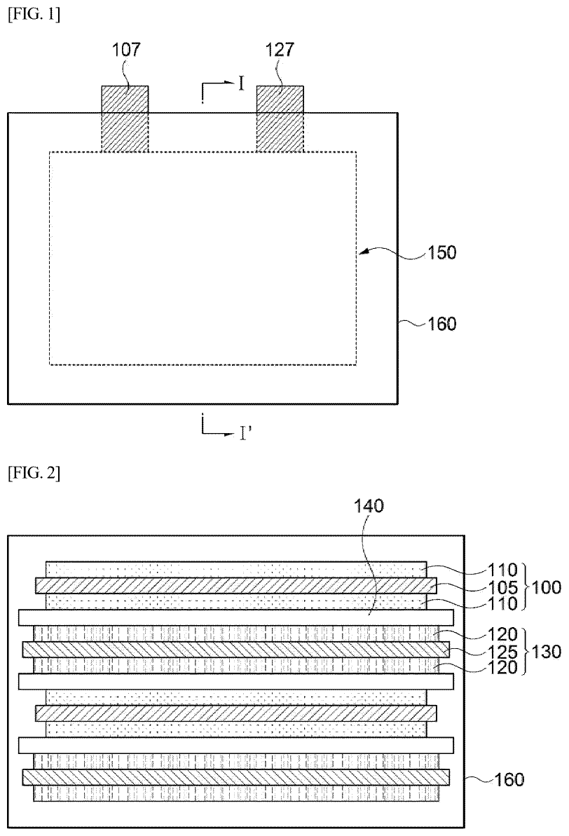

FIGS. 1 and 2 are schematic plan and cross-sectional views illustrating a lithium secondary battery according to exemplary embodiments, respectively. For example, FIG. 2 is a cross-sectional view taken on line I-I′ in FIG. 1.

Referring to FIGS. 1 and 2, the lithium secondary battery may include an electrode assembly including a cathode 100, an anode 130 and a separation membrane 140 interposed between the cathode and the anode. The electrode assembly may be accommodated in a case 160 together with the electrolyte to be impregnated therein by the electrolyte.

The cathode 100 may include a cathode current collector 105 and a cathode active material layer 110 on the cathode current collector 105. For example, the cathode active material layer 110 may include a cathode active material, and if necessary, a cathode binder and a conductive material.

For example, the cathode active material may include a compound capable of reversibly intercalating and deintercalating lithium ions.

In exemplary embodiments, the cathode active material may include a lithium-transition metal oxide. For example, the lithium-transition metal oxide may include nickel (Ni), and may further include at least one of cobalt (Co) and manganese (Mn).

For example, the lithium-transition metal oxide may include a layered structure represented by Formula 4 below.

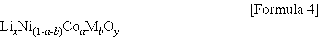

For example, in Formula 4, M may be at least one of Al, Zr, Ti, Cr, B, Mg, Mn, Ba, Si, Y, W and Sr, and x, y, a and b may satisfy 0.95≤x≤1.2, 1.9≤y≤2.1, 0≤a+b≤0.5.

In some embodiments, a+b may satisfy 0<a+b≤0.4, 0<a+b≤0.3, 0<a+b≤0.2, 0<a+b≤0.17, 0<a+b≤0.15, 0<a+b≤0.12, 0<a+b≤0.1.

As shown in Formula 4 above, the lithium-transition metal compound may include Ni among Ni, Co and M in the greatest amount or molar ratio. Ni may function as a metal substantially related to the output and/or capacity of the lithium secondary battery, and by including Ni in the greatest amount among transition metals, a high-capacity, high-output lithium secondary battery may be implemented.

When the content of Ni in the cathode active material or lithium-transition metal oxide increases, the chemical stability of the secondary battery, such as high-temperature storage stability, may be relatively degraded. In addition, sufficient high-output and high-capacity characteristics resulting from the high Ni content may not be implemented due to surface damage of the cathode active material or side reactions with the electrolyte during repeated charge/discharge cycles.

In one embodiment, lithium metal oxide particles may further include a coating element or a doping element. For example, the coating element or doping element may include Al, Ti, Ba, Zr, Si, B, Mg P, Sr, W, La or an alloy or oxide thereof. In this case, a lithium secondary battery with improved cycle life characteristics may be implemented.

A slurry may be prepared by mixing and stirring the cathode active material with a binder, a conductive material and/or a dispersant in a solvent. The cathode current collector 105 may be coated with the slurry, then compressed and dried to prepare the cathode 100.

The cathode current collector 105 may include, for example, stainless steel, nickel, aluminum, titanium, copper or an alloy thereof, and preferably includes aluminum or an aluminum alloy.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as the cathode binder. In this case, an amount of the binder for forming the cathode active material layer may be reduced and an amount of the cathode active material may be relatively increased, thereby improving the output and capacity of the secondary battery.

The conductive material may be included to promote electron migration between the active material particles. For example, the conductive material may include carbon-based conductive materials such as graphite, carbon black, graphene, or carbon nanotubes and/or metal-based conductive materials, including perovskite materials, such as tin, tin oxide, titanium oxide, LaSrCoO₃, and LaSrMnO₃, etc.

The anode 130 may include an anode current collector 125, and an anode active material layer 120 formed by coating the anode current collector 125 with an anode active material. If necessary, the anode may include an anode binder and a conductive material.

The anode active material usable herein may include any material known in the related art, as long as it can intercalate and deintercalate lithium ions, without particular limitation thereof. For example, carbon-based materials such as crystalline carbon, amorphous carbon, carbon composite, carbon fiber, etc.; a lithium alloy; a silicon (Si) compound or tin, etc. may be used. Examples of the amorphous carbon may include hard carbon, cokes, mesocarbon microbead (MCMB), mesophase pitch-based carbon fiber (MPCF) or the like.

Examples of the crystalline carbon may include graphite-based carbon such as natural graphite, artificial graphite, graphite cokes, graphite MCMB, graphite MPCF or the like. Other elements included in the lithium alloy may include, for example, aluminum, zinc, bismuth, cadmium, antimony, silicon, lead, tin, gallium or indium, etc.

The silicon compound may include, for example, silicon, silicon oxide or a silicon-carbon composite compound such as silicon carbide (SiC).

For example, when the anode active material includes the silicon-based active material, there may be a problem in that the thickness of the battery is increased during repeated charging and discharging. The lithium secondary battery according to exemplary embodiments may include the above-described electrolyte to relieve a thickness increase rate of the battery.

In some embodiments, the content of the silicon-based active material may be 1 to 20 wt %, 1 to 15 wt %, or 1 to 10 wt % based on the anode active material.

For example, a slurry may be prepared by mixing and stirring the anode active material with a binder, a conductive material and/or a dispersant in a solvent. The anode current collector 125 may be coated with the slurry, then compressed and dried to prepare the anode active material layer 120.

For example, an anode slurry may be prepared by mixing the anode active material with the above-described components in a solvent. The anode slurry may be applied or deposited on the anode current collector, then dried and roll-pressed to prepare the anode active material layer 120. The coating process may be performed using methods such as gravure coating, slot die coating, simultaneous multilayer die coating, imprinting, doctor blade coating, dip coating, bar coating or casting, etc., but it is not limited thereto. The anode active material layer 120 may further include a binder and optionally further include a conductive material, a thickener, etc.

Non-limiting examples of the solvent may include water, pure water, deionized water, distilled water, ethanol, isopropanol, methanol, acetone, n-propanol, t-butanol, etc.

The above-described materials that can be used when manufacturing the cathode as the binder, conductive material and thickener may also be used.

In some embodiments, a styrene-butadiene rubber (SBR)-based binder, carboxymethyl cellulose (CMC), polyacrylic acid-based binder, poly(3,4-ethylenedioxythiophene, PEDOT)-based binder, and the like may be used as an anode binder.

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fibers having a high melting point, polyethylene terephthalate fibers, etc.

In some embodiments, the anode 130 may have an area (e.g., a contact area with the separation membrane 140) and/or volume larger than those/that of the cathode 100. Thereby, lithium ions generated from the cathode 100 may smoothly migrate to the anode 130 without being precipitated during the process, for example.

According to exemplary embodiments, an electrode cell is defined by the cathode 100, the anode 130 and the separation membrane 140, and a plurality of electrode cells may be stacked to form, for example, a jelly roll type electrode assembly 150. For example, the electrode assembly 150 may be formed by winding, laminating, folding, and the like the separation membrane 140.

The electrode assembly 150 may be accommodated in the case 160 together with the non-aqueous electrolyte according to the above-described exemplary embodiments to define the lithium secondary battery. According to exemplary embodiments, the non-aqueous electrolyte may be used as the electrolyte.

As shown in FIG. 1, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape, a coin shape or the like.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Example 1

### (1) Preparation of Non-Aqueous Electrolyte Including Compound (A-1) of Formula 2 and Sulfur Compound

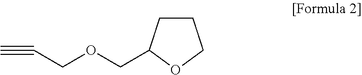

0.5 wt % of 1,3-propane sultone (PS), 0.5 wt % of ethylene sulfate (ESA), 3 wt % of fluoroethylene carbonate (FEC), and 1 wt % of lithium difluorophosphate (LiPO₂F₂) were added to a mixed solvent in which ethylene carbonate (EC), ethyl methyl carbonate (EMC) and diethyl carbonate (DEC) were mixed in a volume ratio of 25:45:30. Subsequently, LiPF₆ was dissolved in the above mixture so as to have a concentration of 1.0 M, which was used as a base electrolyte, and then 0.5 wt % of the compound (A-1) of Formula 2 above was added thereto to prepare a non-aqueous electrolyte.

### (2) Manufacture of Lithium Secondary Battery

LiNi_{0.88}Co_{0.06}Mn_{0.06}O₂ as a cathode active material, polyvinylidene fluoride (PVdF) as a binder, and carbon as a conductive material were mixed in a weight ratio of 98:1:1, and then the mixture was dispersed in N-methyl-2-pyrrolidone to prepare a cathode slurry. An aluminum foil having a thickness of 12 μm was coated with the slurry, then dried and roll-pressed to prepare a cathode.

Artificial graphite and natural graphite as anode active materials, styrene-butadiene rubber as a binder, and carboxymethyl cellulose as a thickener were mixed in a weight ratio of 96:2:2, and then the mixture was dispersed in water to prepare an anode active material slurry. A copper foil having a thickness of 8 μm was coated with the slurry, then dried and roll-pressed to prepare an anode.

A film separator made of polyethylene (PE) material with a thickness of 13 μm was stacked between the prepared electrodes, and a cell was assembled using a pouch having dimensions of 5 mm (thickness)×50 mm (width)×60 mm (length). Then, the non-aqueous electrolyte was injected to manufacture a 2 Ah-class lithium secondary battery for an electric vehicle (EV).

### Example 2

A lithium secondary battery was manufactured in the same manner as in Example 1, except that a non-aqueous electrolyte was prepared by using the compound (A-2) of Formula 3 below instead of the compound (A-1) of Formula 2 in Example 1 above.

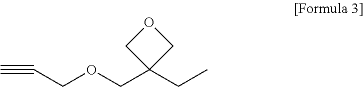

### Example 3

A lithium secondary battery was manufactured in the same manner as in Example 1, except that a non-aqueous electrolyte solution was prepared by including 2.0 wt % of the compound (A-1) of Formula 2 in Example 1 above.

### Example 4

A lithium secondary battery was manufactured in the same manner as in Example 2, except that a non-aqueous electrolyte solution was prepared by including 2.0 wt % of the compound (A-2) of Formula 3 in Example 2 above.

### Comparative Example 1

A lithium secondary battery was manufactured in the same manner as in Example 1, except that a non-aqueous electrolyte solution was prepared without including the compound (A-1) of Formula 2 in Example 1 above.

### Comparative Example 2

A lithium secondary battery was manufactured in the same manner as in Example 1, except that a non-aqueous electrolyte was prepared by using the compound (B-2) of Formula 5 below instead of the compound (A-1) of Formula 2 in Example 1 above.

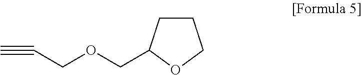

### Comparative Example 3

A lithium secondary battery was manufactured in the same manner as in Example 1, except that a non-aqueous electrolyte was prepared without including 0.5 wt % of 1,3-propane sultone (PS) and 0.5 wt % of ethylene sulfate (ESA) in Example 1 above.

### Comparative Example 4

A lithium secondary battery was manufactured in the same manner as in Example 2, except that a non-aqueous electrolyte was prepared without including 0.5 wt % of 1,3-propane sultone (PS) and 0.5 wt % of ethylene sulfate (ESA) in Example 2 above.

The types and contents of additives, the types and contents of sulfur compounds, and the types and contents of auxiliary additives included in the electrolytes of the examples and comparative examples are as summarized in Table 1 below.

TABLE 1

| | Additive | | Sulfur compound content | | Auxiliary additive content | |
|---|---|---|---|---|---|---|
| | | Content | [wt %] | | [wt %] | |
| | Compound | [wt %] | PS | ESA | FEC | LiPO₂F₂ |
| Example 1 | A-1 | 0.5 | 0.5 | 0.5 | 3.0 | 1.0 |
| Example 2 | A-2 | 0.5 | 0.5 | 0.5 | 3.0 | 1.0 |
| Example 3 | A-1 | 2.0 | 0.5 | 0.5 | 3.0 | 1.0 |
| Example 4 | A-2 | 2.0 | 0.5 | 0.5 | 3.0 | 1.0 |
| Comparative | — | — | 0.5 | 0.5 | 3.0 | 1.0 |
| Example 1 | | | | | | |
| Comparative | B-1 | 0.5 | 0.5 | 0.5 | 3.0 | 1.0 |
| Example 2 | | | | | | |
| Comparative | A-1 | 0.5 | — | — | 3.0 | 1.0 |
| Example 3 | | | | | | |
| Comparative | A-2 | 0.5 | — | — | 3.0 | 1.0 |
| Example 4 | | | | | | |

For the lithium secondary batteries of the examples and comparative examples, evaluations were performed according to the following experimental examples, and the results are shown in Table 2.

### Experimental Example 1: Evaluation of Initial Performance

### 1) Measurement of Initial Discharge Capacity

The lithium secondary batteries according to the above-described examples and comparative examples were each charged (CC-CV 1.0C 4.2V 0.05C CUT-OFF) and discharged (CC 1.0C 3.0V CUT-OFF) once at 25° C., and the initial discharge capacity was then measured.

### 2) Measurement of Initial Discharge Internal Resistance (DCIR)

The lithium secondary batteries of the examples and comparative examples were subjected to 0.5C CC/CV charge (4.2V 0.05C CUT-OFF) at room temperature (25° C.), and then 0.5C CC discharge up to a state of charge (SOC) of 60%. At the SOC 60 point, the batteries were discharged and recharged for 10 seconds, respectively, while varying the C-rate to 0.2C, 0.5C, 1C, 1.5C, 2C and 2.5C, and then the DCIR was measured.

### Experimental Example 2: Evaluation of High-Temperature Storage Characteristics

### 1) Measurement of Capacity Retention Rate

The lithium secondary batteries of the examples and comparative examples were subjected to 0.5C CC/CV charge (4.2V, 0.05C CUT-OFF) and 0.5C CC discharge (2.7V CUT-OFF) three times each at 25° C., and the discharge capacities C1 at the third cycle were measured. The charged lithium secondary batteries were stored at 60° C. for 8 weeks, then additionally left at room temperature for 30 minutes, and subsequently subjected to 0.5C CC discharge (2.75V CUT-OFF), where the discharge capacities C2 were measured. The capacity retention rate was calculated according to Equation 1 below and the results thereof are shown in Table 1 below.

$$Capacity rention rate ( \% ) = C 2 / C 1 \times 100 ( \% ) \qquad [ Equation 1 ]$$

### 2) Measurement of Battery Thickness Increase Rate

The lithium secondary batteries of the examples and comparative examples were subjected to 0.5C CC/CV charge (4.2V 0.05C CUT-OFF) at 25° C., and then the battery thickness T1 was measured.

After the lithium secondary batteries of the examples and comparative examples were left under ambient exposure conditions at 60° C. for 8 weeks, the battery thickness T2 was measured at room temperature. The battery thickness was measured using a flat plate thickness measuring device (Mitutoyo, 543-490B). The battery thickness increase rate was calculated according to Equation 2 below.

$$Battery thickness increase rate ( \% ) = ( T 2 - T 1 ) / T 1 \times 100 ( \% ) \qquad [ Equation 2 ]$$

### Experimental Example 3: Evaluation of High-Temperature Cycle Life Characteristics

The lithium secondary batteries of the examples and comparative examples were subjected to 1.0C CC/CV charge (4.2V, 0.05C CUT-OFF) and 1.0C CC discharge (2.7V CUT-OFF) for 500 cycles at 45° C. At this time, the discharge capacity at the first cycle was referred to as C, and the high-temperature cycle life capacity retention rate was determined by dividing the discharge capacity at the 500th cycle by the discharge capacity at the first cycle.

TABLE 2

| | | | | | High- |
|---|---|---|---|---|---|
| | | | | | temperature |
| | | | High-temperature | | cycle life |
| | Initial | | storage characteristics | | characteristics |
| | performance | | Capacity | Thickness | Capacity |
| | Capacity | DCIR | retention | increase | retention |
| | (mAh) | (mΩ) | rate (%) | rate (%) | rate (%) |
| Example 1 | 1948 | 25.8 | 83.6 | 163.0 | 84.0 |
| Example 2 | 1956 | 25.8 | 82.4 | 147.4 | 86.5 |
| Example 3 | 1912 | 29.6 | 83.4 | 134.2 | — |
| Example 4 | 1929 | 28.4 | 78.4 | 144.6 | — |
| Comparative | 1967 | 26.0 | 78.5 | 165.3 | 82.1 |
| Example 1 | | | | | |
| Comparative | 1961 | 25.8 | 80.4 | 165.8 | — |
| Example 2 | | | | | |
| Comparative | 1942 | 27.8 | 71.3 | 223.2 | — |
| Example 3 | | | | | |
| Comparative | 1953 | 26.9 | 63.3 | 238.2 | — |
| Example 4 | | | | | |

Referring to Table 2 above, the lithium secondary batteries of the examples include the electrolyte including a compound containing a carbon-carbon triple bond, a linear ether group, and a 4- or 5-membered cyclic ether group, and a sulfur compound including a sulfur-containing heterocyclic structure. Accordingly, the capacity of the lithium secondary batteries of the examples was maintained at a higher level during high-temperature storage. In addition, the thickness increase rate of the batteries of the examples stored at high temperatures was reduced compared to that of the comparative examples.

The lithium secondary battery of Comparative Example 1 includes an electrolyte that includes a compound which does not include a carbon-carbon triple bond, a linear ether group, and a 4- or 5-membered cyclic ether group. Therefore, due to excessive side reactions of the electrolyte, the capacity retention rate was reduced during high-temperature storage, and the thickness increase rate was increased. In addition, the high-temperature cycle life characteristics were degraded compared to the examples.

The lithium secondary battery of Comparative Example 2 includes an electrolyte that includes a compound containing a carbon-carbon double bond, a linear ether group, and a 5-membered cyclic ether group. Since the carbon-carbon double bond has a lower bond strength than the carbon-carbon triple bond, the thermal stability was decreased. Accordingly, the thickness increase rate was increased during high-temperature storage.

The lithium secondary batteries of Comparative Examples 3 and 4, which do not include a sulfur compound, showed a rapid decrease in the capacity retention rate during high-temperature storage. In addition, the thickness increase rate was increased by 200% or more during high-temperature storage, resulting in reduced performance and stability of the batteries.

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. An electrolyte for a lithium secondary battery comprising:
a lithium salt;
an organic solvent;
an additive comprising a compound including a carbon-carbon triple bond, a linear ether group, and a 4- or 5-membered cyclic ether group; and
a sulfur compound including a sulfur-containing heterocyclic structure.

2. The electrolyte for a lithium secondary battery according to claim 1, wherein the compound is represented by Formula 1 below: 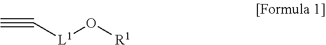
(in Formula 1, L¹ is an alkylene group having 1 to 5 carbon atoms, and R¹ is a hydrocarbon group having 3 to 30 carbon atoms and including a 4- or 5-membered cyclic ether group).

3. The electrolyte for a lithium secondary battery according to claim 2, wherein L¹ in Formula 1 above is a methylene group.

4. The electrolyte for a lithium secondary battery according to claim 2, wherein R¹ in Formula 1 above is a hydrocarbon group having 3 to 6 carbon atoms and including a 4- or 5-membered cyclic ether group.

5. The electrolyte for a lithium secondary battery according to claim 1, wherein the content of the additive is 0.1% by weight to 10% by weight based on the total weight of the electrolyte.

6. The electrolyte for a lithium secondary battery according to claim 1, wherein the content of the additive is 0.2% by weight to 0.5% by weight based on the total weight of the electrolyte.

7. The electrolyte for a lithium secondary battery according to claim 1, wherein the sulfur compound includes at least one oxygen-sulfur double bond.

8. The electrolyte for a lithium secondary battery according to claim 1, wherein the sulfur compound includes a sultone compound or a cyclic sulfate compound.

9. The electrolyte for a lithium secondary battery according to claim 1, wherein the sulfur compound comprises at least one selected from the group consisting of 1,3-propane sultone, 1,3-propene sultone, 1,4-butane sultone, 1,2-ethylene sulfate, 1,2-propylene sulfate, trimethylene sulfate, and methyltrimethylene sulfate.

10. The electrolyte for a lithium secondary battery according to claim 1, wherein the content of the sulfur compound is 0.01% by weight to 10% by weight based on the total weight of the electrolyte.

11. The electrolyte for a lithium secondary battery according to claim 1, wherein a ratio of the content of the sulfur compound to the content of the additive in the total weight of the electrolyte is 0.1 to 10.

12. The electrolyte for a lithium secondary battery according to claim 1, further comprising an auxiliary additive including at least one selected from the group consisting of an unsaturated cyclic carbonate compound, a halogen-substituted cyclic carbonate compound, a fluorine-substituted phosphate compound, and an oxalato phosphate compound.

13. The electrolyte for a lithium secondary battery according to claim 12, wherein the content of the auxiliary additive is 0.1% by weight to 10% by weight based on the total weight of the electrolyte.

14. A lithium secondary battery comprising:
a cathode;
an anode disposed opposite to the cathode; and
the electrolyte for a lithium secondary battery according to claim 1.
